(19) United States
(12) Patent Application Publication
(10) Pub. No.: US 2014/0067452 A1
(43) Pub. Date: Mar. 6, 2014

(54) INTELLIGENT WORK MANAGEMENT BASED ON SATELLITE NAVIGATION SYSTEM DATA AND NETWORK NODE DATA

(71) Applicants: Eric Anderson, Friendswood, TX (US); Christopher J. Dawson, Arlington, VA (US); Guy Lain Tarrant Sidford, Redditch (GB)

(72) Inventors: Eric Anderson, Friendswood, TX (US); Christopher J. Dawson, Arlington, VA (US); Guy Lain Tarrant Sidford, Redditch (GB)

(73) Assignee: INTERNATIONAL BUSINESS MACHINES CORPORATION, Armonk, NY (US)

(21) Appl. No.: 13/599,100

(22) Filed: Aug. 30, 2012

(51) Int. Cl. G06Q 10/06

(52) U.S. Cl. 705/7.14; 705/7.13

(57) ABSTRACT

A method, computer program product, and computer system for intelligently assigning a work task to an agent. From a database, the computer system retrieves information of a location of the work task and information of agent locations determined by a satellite navigation system. The computer system selects one or more candidate agents who are within a predetermined range of the location of the work task, based on the agent locations determined by the satellite navigation system. Retrieving network node data and location information of routers or repeaters in a network, the computer system determines locations of the one or more candidate agents. The computer system chooses a best available agent for the work task from the one or more candidate agents, based on the location of the work task and the locations of the one or more candidate agents.

### FIELD OF THE INVENTION

The present invention relates generally to a computer system and method for intelligent work management, and more particularly to a computer system and method for intelligently assigning work tasks to agents based on satellite navigation system data and network node data.

### BACKGROUND

A work management system, such as a trouble ticket system, applies intelligence to routing work more efficiently based on conditions such as skills, workloads, and agent's current locations. The idea is to limit the amount of travel time of an agent. Currently, routing work is based on either triangulation of satellite navigation system such as GPS (Global Positioning System) coordinates or previously routed work. With the widespread availability of GPS and inexpensive GPS receivers, determination of locations using GPS is a good solution for outdoor situations. A common method of assigning work based on previously routed work is known as the traveling salesman algorithm. A work assignment is based on the previous location of an agent, a path, or a route to a destination.

### SUMMARY

Embodiments of the present invention provide a method, computer program product, and computer system for intelligently assigning a work task to an agent. The computer system receives a request for assigning the work task to the agent. The computer system retrieves, from a database, information of a location of the work task. From the database, the computer system retrieves information of agent locations determined by a satellite navigation system. The computer system selects one or more candidate agents who are within a predetermined range of the location of the work task, based on the agent locations determined by the satellite navigation system. From agent devices of the one or more candidate agents, the computer system retrieves network node data of routers or repeaters in a network. From the database, the computer system retrieves location information of the routers or the repeaters. Based on the location information of the routers or the repeaters, the computer system determines locations of the one or more candidate agents. And, the computer system chooses a best available agent for the work task from the one or more candidate agents, based on the location of the work task and the locations of the one or more candidate agents.

### BRIEF DESCRIPTION OF THE SEVERAL VIEWS OF THE DRAWINGS

FIG. 1 is a diagram illustrating a system for intelligently assigning work tasks to agents based on satellite navigation system data and network node data, in accordance with an exemplary embodiment of the present invention.

FIG. 2 is a diagram illustrating data flow of the system shown in FIG. 1 for periodically updating agent locations based on satellite navigation system data, in accordance with an exemplary embodiment of the present invention.

FIG. 3 is a diagram illustrating data flow of the system shown in FIG. 1 for assigning a work task to an agent, in accordance with an exemplary embodiment of the present invention.

FIG. 4 is a diagram illustrating determination of agent locations in an office building based on GPS data, in accordance with an exemplary embodiment of the present invention.

FIGS. 5A and 5B are diagrams illustrating determination of an agent location in an office building based on a router location, in accordance with an exemplary embodiment of the present invention.

FIG. 6 is a flowchart illustrating operational steps of intelligently assigning a work task to an agent by a work management system shown in FIG. 1, in accordance with an exemplary embodiment of the present invention.

FIG. 7 is a diagram of a computer device hosting a work management system and a configuration management database (CMDB) shown in FIG. 1, in accordance with an exemplary embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

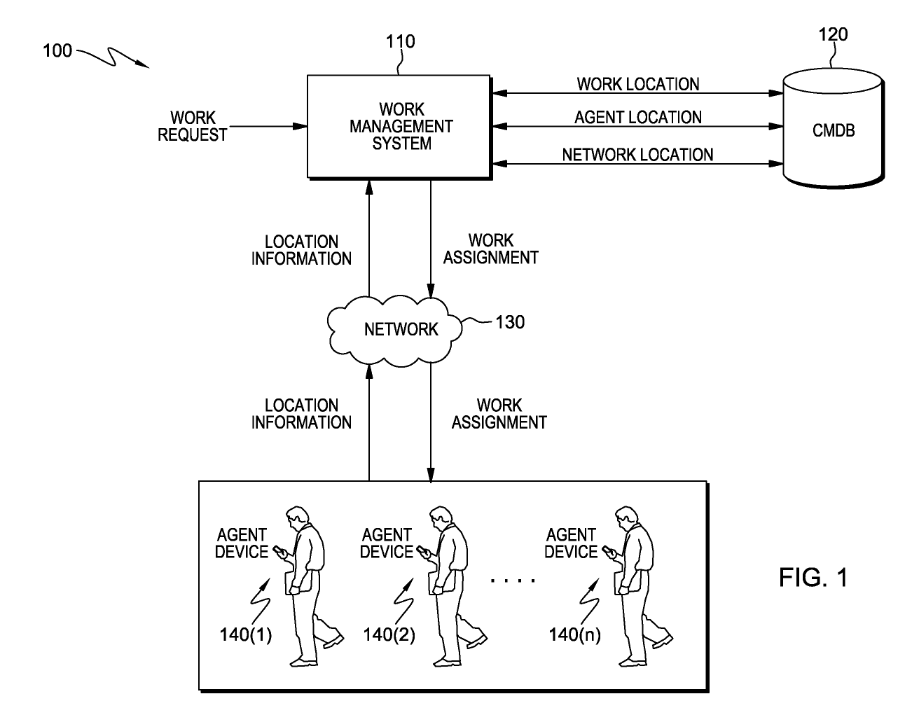

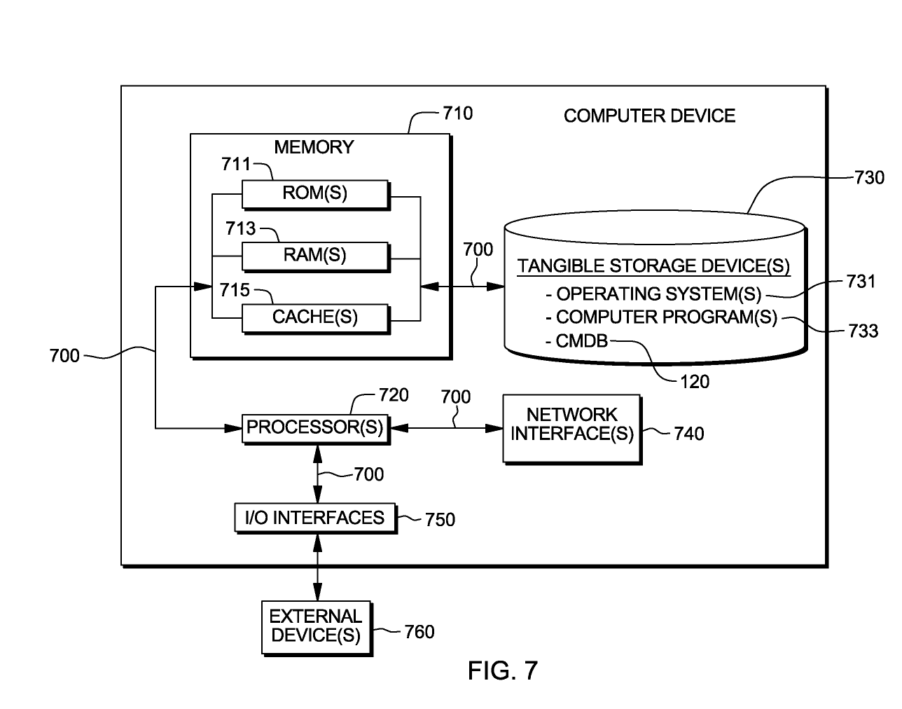

FIG. 1 is a diagram illustrating system 100 for intelligently assigning work tasks to agents based on satellite tracking system data and network node data, in accordance with an exemplary embodiment of the present invention. System 100 comprises work management system 110, configuration management database (CMDB) 120, network 130, and a plurality of agent devices 140(1), 140(2), . . . , and 140(n). The plurality of agent devices 140(1), 140(2), . . . , and 140(n) are used by a plurality of agents. Work management system 110 is hosted by at least one computer device which is discussed in latter paragraphs with reference to FIG. 7. CMDB 120 is a database which is either hosted by the at least one computer device hosting work management system 110 or by another at least one computer device. In the exemplary embodiment, network 130 comprises a plurality of routers and may also comprise a plurality of repeaters. The routers or the repeaters provide agent devices 140(1), 140(2), . . . , and 140(n) with wireless access to network 130. Agent devices 140(1), 140(2), . . . , and 140(n) include smartphones, tablet computers, laptop computers, personal digital assistants (PDAs), or any mobile computing devices, which are capable of connecting to network 130, receiving satellite navigation system signals to determine locations, and communicating with work management system 110 via network 130.

Referring to FIG. 1, work management system 110 receives a work request for assigning a work task to an agent. The work request may be received automatically from another computer system submitting work requests or from a manual entry of an administrator of work management system 110. In response to receiving the work request, work management system 110 retrieves, from CMDB 120, information of a work location (i.e., the location of the work task). Work management system 110 also retrieves, from CMDB 120, information of agent locations (i.e., locations of the plurality of agents). The locations of the plurality of agents are most recently recorded on CMDB 120 and are determined based on satellite navigation system data (such as GPS data) received by agent devices 140(1), 140(2), . . . , and 140(n). Using the information of the locations of the plurality of agents, work management system 110 selects, from the plurality of the agents, one or more candidate agents who are within a predetermined range of the work location.

To determine locations of the candidate agents, work management system 110 acquires, through network 130, network node data from agent devices of the one or more candidate agents, one or more devices from agent devices 140(1), 140(2), . . . , and 140(n). The network node data includes IP addresses of the routers and/or media access control (MAC) addresses of the repeaters. The network node data used for determining the locations of the candidate agents are the addresses (the IP addresses and/or the MAC addresses) of the routers and/or repeaters that furnish strongest wireless signals to the agent devices of the one or more candidate agents or are currently used by the agent devices of the one or more candidate agents. To determine locations of the candidate agents, work management system 110 also retrieves, from CMDB 120, network location information. On CMDB 120, data of physical locations of the routers and/or repeaters are mapped to data of the IP addresses and/or the MAC addresses of the routers and/or repeaters; thus, CMDB 120 provides work management system 110 with physical locations of the routers and/or the repeaters. Based on the physical locations of the routers and/or the repeaters, work management system 110 determines the locations of the one or more candidate agents.

Referring to FIG. 1, after choosing a best available agent from the one or more candidate agents, work management system 110 sends, through network 130, a work assignment to one of agent devices 140(1), 140(2), . . . , and 140(n). The one of agent devices 140(1), 140(2), . . . , and 140(n) is used by the best available agent.

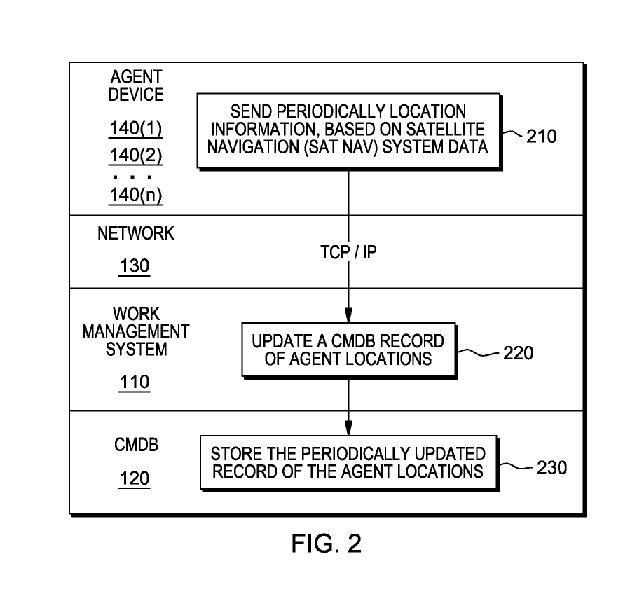

FIG. 2 is a diagram illustrating data flow of system 100 shown in FIG. 1 for periodically updating agent locations based on satellite navigation system data, in accordance with an exemplary embodiment of the present invention. As shown in block 210, agent devices 140(1), 140(2), . . . , and 140(n) send periodically to work management system 110 location information which is based on satellite navigation system data (such as GPS data). Via network 130, the location information from agent devices 140(1), 140(2), . . . , and 140(n) is sent to work management system 110. In the exemplary embodiment, Transmission Control Protocol and Internet Protocol (TCP/IP) are used as communication protocols in network 130. As shown in block 220, in response to receiving the location information, work management system 110 updates, on CMDB 120, a record of agent locations that are determined by a satellite navigation system (e.g. GPS). As shown in block 230, CMDB 120 stores the periodically updated record of agent locations. The record of the agent locations based on satellite navigation system data are periodically updated at a predetermined time interval. The periodically updated record on CMDB 120 furnishes information of last known locations of a plurality of agents. Work management system 110 uses the periodically updated record to select the one or more candidate agents who are in the vicinity of the location of the work task.

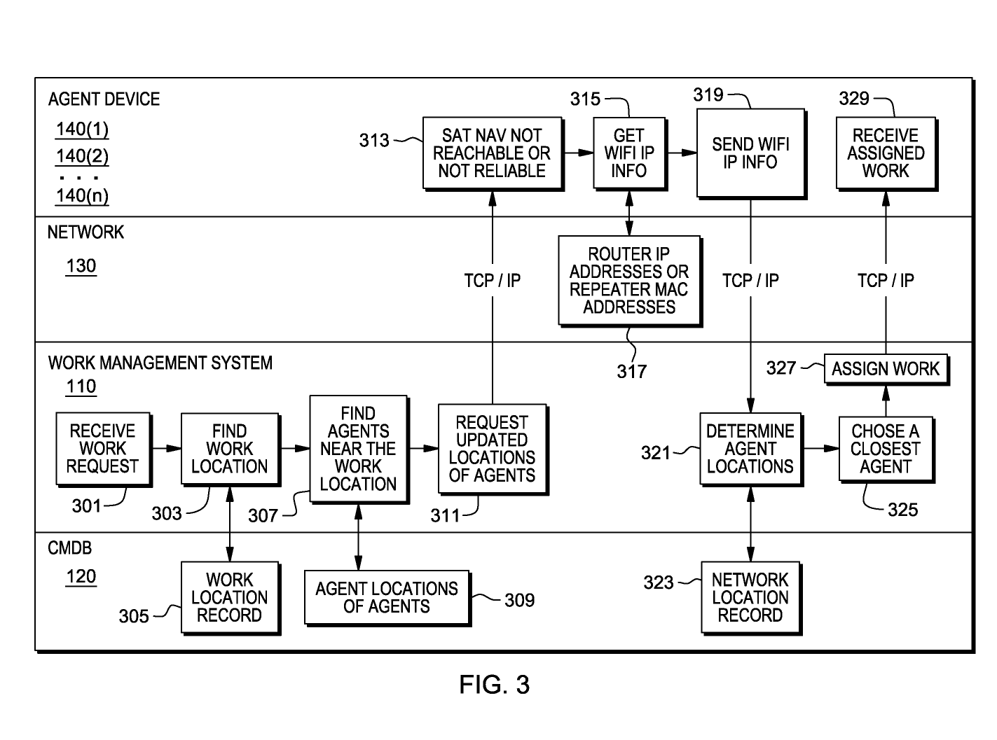

FIG. 3 is a diagram illustrating data flow of system 100 shown in FIG. 1 for assigning a work task to an agent, in accordance with an exemplary embodiment of the present invention. Work management system 110 receives a work request for assigning a work task to an agent (block 301) and then finds the work location where the work task is to be done (block 303) by retrieving a work location record on CMDB 120 (block 305). Once the work location of the work task is found, work management system 110 finds one or more candidate agents who are in the vicinity of the work location (block 307) by conducting a search in a periodically updated record of agent locations stored on CMDB 120. The periodically updated record stores the last known locations of a plurality of agents (block 309), and the last known locations is based on satellite navigation system data. As shown in block 311, work management system 110 sends, through network 130, a request for updating current locations to agent devices of the one or more candidate agents, one or more devices from agent devices 140(1), 140(2), . . . , and 140(n). In network 130, Transmission Control Protocol and Internet Protocol (TCP/IP) are used as communication protocols.

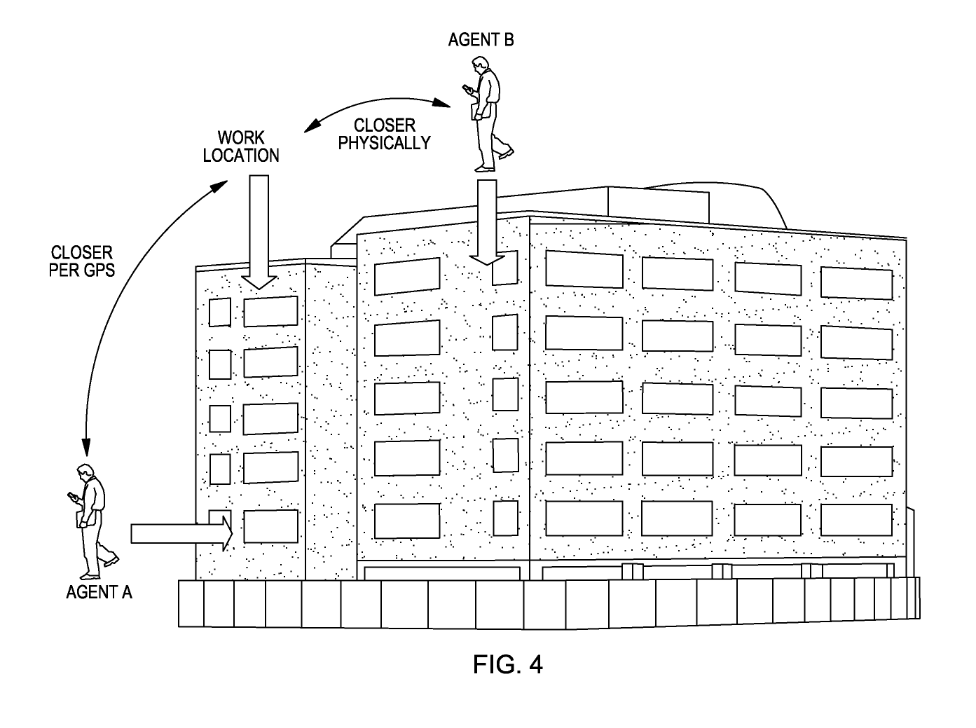

Referring to FIG. 3, as shown in block 313, the agent devices of the one or more candidate agents cannot determine the current agent locations based on satellite navigation system data because the satellite navigation system signals are not reachable in a building. In another scenario, although the satellite navigation signals may be available in a building, the satellite navigation system signals cannot identify locations in altitude in a building which has multiple floors. Therefore, determination of agent locations solely based on the satellite navigation system data is not reliable in the building with multiple floors. This scenario is illustrated in FIG. 4 which shows an example. As shown in FIG. 4, based on the satellite navigation system data (e.g. GPS data), agent A on the first floor is considered as closer to the work location on the fifth floor. However, agent B on the fifth floor is actually closer to the work location than agent A. Thus, determination of exact locations of the one or more candidate agents must rely on another way, more specifically on network node data.

Referring to FIG. 3, because the satellite navigation signals are not reachable by the agent devices of the one or more candidate agents or not reliable to determine the exact locations of the candidate agents, the agent devices of the one or more candidate agents capture WIFI IP information of the routers or the repeaters in network 130 (block 315). As shown in block 317, the IP information includes router IP addresses or repeater MAC addresses. Then, as shown in block 319, the agent devices of the one or more candidate agents send, through network 130, the WIFI IP information to work management system 110.

Referring to FIG. 3, as shown in block 321, in response to receiving the IP information, work management system 110 determines current locations of the one or more candidate agents by retrieving the network location record on CMDB 120. The network location record (block 323) stored on CMDB 120 includes a physical location of each of the routers and/or repeaters. Then, as shown in block 325, work management system 110 chooses a best available agent from the one or more candidate agents. In this exemplary embodiment, among the one or more candidate agents, the best available agent is closest to the work location. Finally, work management system 110 assigns the work task to the best available agent (block 327), and the agent device used by the best available agent receives the work assignment (block 329).

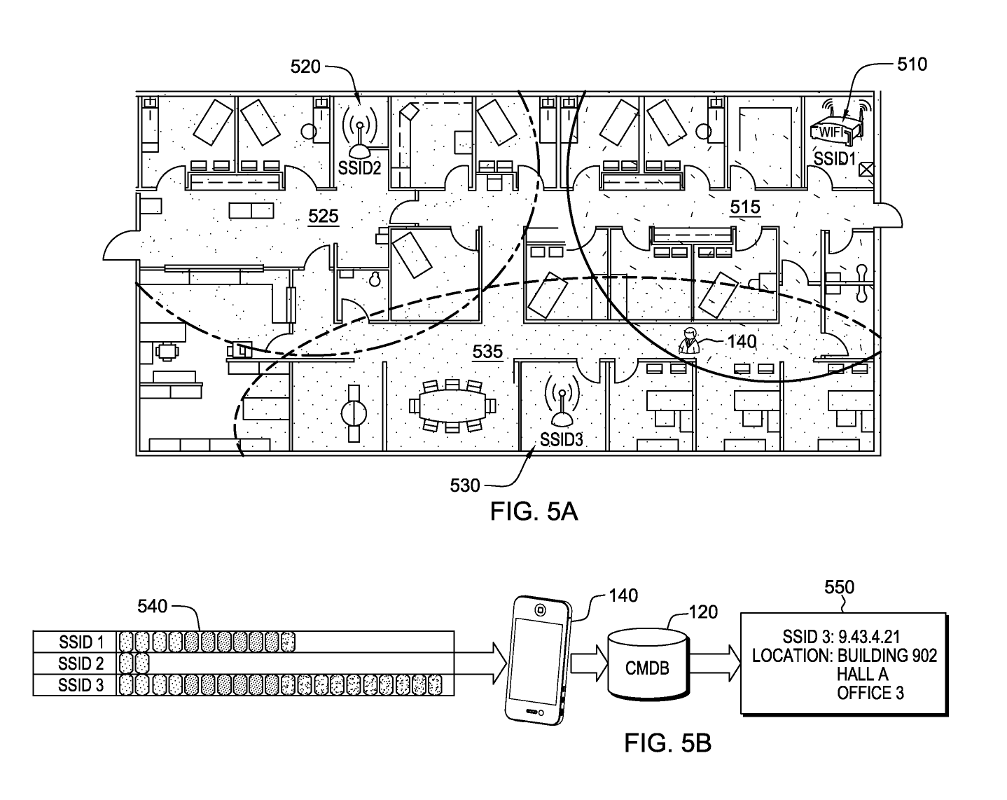

FIGS. 5A and 5B are diagrams illustrating determination of an agent location in an office building based on a router location, in accordance with an exemplary embodiment of the present invention. FIGS. 5A and 5B show an example of using wireless routers to determine the agent location. In FIG. 5A, routers 510 (SSID1), 520 (SSID2), and 530 (SSID3) are situated in the building and provide agent device 140 with wireless access. The wireless signals generated by router 510 (SSID1) cover area 515 which is represented by an area enclosed with a solid curve. The wireless signals generated by router 520 (SSID2) cover area 525 which is represented by an area enclosed with a dot-dot-dashed curve. The wireless signals generated by router 530 (SSID3) cover area 535 which is represented by an area enclosed with a dashed curve. Agent device 140 is located within area 535, at the boundary of area 515, and outside area 525. Therefore, agent device 140 receives strong wireless signals from router 530 (SSID3), moderate wireless signals from router 510 (SSID1), and weak wireless signals from router 520 (SSID2). Block 540 in FIG. 5B demonstrates the strength of wireless signals that agent device 140 receives.

In the exemplary embodiment, router 530 (SSID3), which furnishes the strong signal to agent device 140, is used by work management system 110 to identify the agent location. Work management system 110 retrieves IP information from agent device 140 and physical location information of router 530 (SSID3) from CMDB 120. On CMDB 120, physical locations of routers 510 (SSID1), 520 (SSID2), and 530 (SSID3) are mapped to the IP addresses and/or the MAC addresses thereof. Block 550 in FIG. 5B demonstrates the IP address and the physical location of router 530 (SSID3). An agent with agent device 140 is physically closer to router 530; therefore, the physical location of router 530 (SSID3) is used when work management system 110 determines whether the agent is a best available agent for a work assignment.

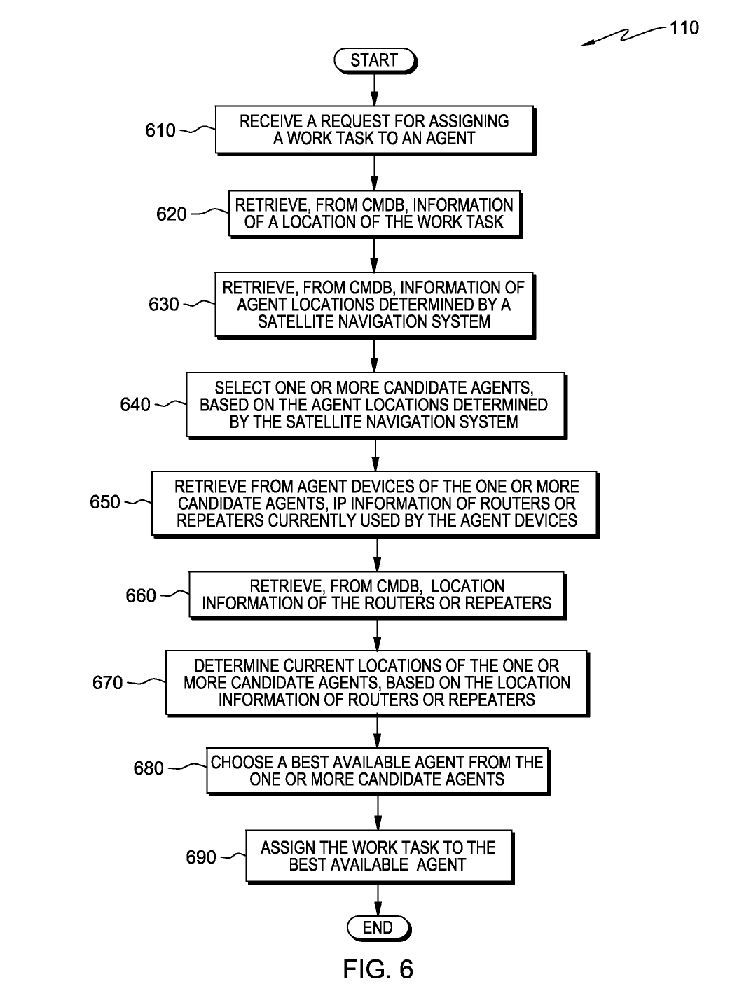

FIG. 6 is a flowchart illustrating operational steps of intelligently assigning a work task to an agent by work management system 110 shown in FIG. 1, in accordance with an exemplary embodiment of the present invention. At step 610, work management system 110 receives a request for assigning a work task to an agent. The request may be received automatically from another computer system submitting work requests or from a manual entry of an administrator of work management system 110. At step 620, work management system 110 retrieves, from configuration management database (CMDB) 120, information of a location of the work task.

At step 630, work management system 110 retrieves, from CMDB 120, information of agent locations determined by a satellite navigation system such as the Global Positioning System (GPS). As shown in FIG. 2, at a predetermined time interval, agent devices 140(1), 140(2), . . . , and 140(n) send to work management system 110 information of agent locations which are determined based on satellite navigation system data; the agent locations are updated by work management system 110 and recorded on CMDB 120. To select one or more candidate agents from a plurality of agents at the next step, work management system 110 retrieves, from CMDB 120, the periodically updated information of the most recent agent locations of the plurality of agents.

At step 640, based on the agent locations determined by the satellite navigation system, work management system 110 selects, from the plurality of agents, the one or more candidate agents who are within a predetermined range of the location of the work task.

At step 650, work management system 110 retrieves, from the agent devices of the one or more candidate agents, IP information of routers or repeaters. The routers or the repeaters provide agent devices 140(1), 140(2), . . . , and 140(n) with wireless access to network 130. The IP information is the network node data including router IP addresses or repeater MAC addresses. At step 660, work management system 110 retrieves, from CMDB 120, location information of the routers or repeaters. The location information stored on CMDB 120 includes data of the physical locations mapping to data of the router IP addresses or the repeater MAC addresses.

In response to retrieving the IP information of the routers or the repeaters at step 650 and retrieving location information of the routers or the repeaters at step 660, work management system 110, at step 670, determines the locations of the one or more candidate agents. At step 680, work management system 110 chooses a best available agent from the one or more candidate agents. In the exemplary embodiment, the best available agent is chosen by selecting an agent whose location is closest to the location of the work task. In other embodiments, other additional criteria such as skills and workloads of the one or more candidate agents are considered in choosing the best available agent. Finally, at step 690, work management system 110 assigns the work task to the best available agent. The work assignment is sent from work management system 110 to the device used by the best available agent, one of agent devices 140(1), 140(2), . . . , and 140(n).

FIG. 7 is a diagram of a computer device hosting work management system 110 and configuration management database (CMDB) 120, in accordance with an exemplary embodiment of the present invention. It should be appreciated that FIG. 7 provides only an illustration of one implementation and does not imply any limitations with regard to the environment in which different embodiments may be implemented.

In the exemplary embodiment, work management system 110 and CMDB 120 are hosted on a computer device. In other embodiments, work management system 110 and CMDB 120 may be separately hosted on two separate computer devices. Also, in other embodiments, work management system 110 and CMDB 120 may be distributed in a cluster of computers.

Referring to FIG. 7, the computer device includes communications fabric 700 which provides communications among processor(s) 720, memory 710, tangible storage device(s) 730, network interface(s) 740, and I/O (input/output) interface(s) 750. Memory 710 includes ROM(s) (Read Only Memory) 711, RAM(s) (Random Access Memory) 713, and cache(s) 715. One or more operating systems 731 and one or more computer programs 733 reside on one or more computer-readable tangible storage devices 730. One or more computer programs 733 implement functions and operational steps for intelligently assigning a work task to an agent. CMDB 120 also resides on one or more computer-readable tangible storage devices 730.

The computer device further includes I/O interface(s) 750. I/O interface(s) 750 allow for input and output of data with external device(s) 760 that may be connected to the computer device. The computer device further includes network interface(s) 740 for communications between the computer device and network 130.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method implemented by a computer system for intelligently assigning a work task to an agent, the method comprising:
receiving a request for assigning the work task to the agent;
retrieving, from a database, information of a location of the work task;
retrieving, from the database, information of agent locations determined by a satellite navigation system;
selecting one or more candidate agents who are within a predetermined range of the location of the work task, based on the agent locations determined by the satellite navigation system;
retrieving, from agent devices of the one or more candidate agents, network node data of routers or repeaters in a network;
retrieving, from the database, location information of the routers or the repeaters;
determining locations of the one or more candidate agents, based on the location information of the routers or the repeaters; and
choosing a best available agent for the work task from the one or more candidate agents, based on the location of the work task and the locations of the one or more candidate agents.

2. The method of claim 1, further comprising:
updating, on the database, the information of the agent locations determined by the satellite navigation system, at a predetermined time interval.

3. The method of claim 1, wherein the network node data of the routers or the repeaters include IP addresses of the routers or MAC addresses of the repeaters.

4. The method of claim 1, wherein the best available agent is so chosen from the one or more candidate agents that the best available agent is closest to the location of the work task.

5. The method of claim 1, wherein criteria of choosing the best available agent comprise locations, skills, and workloads of the one or more candidate agents.

6. The method of claim 1, wherein the agent devices are mobile computing devices including smartphones, tablet computers, or laptop computers.

7. The method of claim 1, wherein the routers or the repeaters provide the agent devices with wireless access to the network.

8. A computer program product for intelligently assigning a work task to an agent, the computer program product comprising:
one or more computer-readable tangible storage devices and program instructions stored on at least one of the one or more tangible storage devices, the program instructions comprising:
program instructions to receive a request for assigning the work task to the agent;
program instructions to retrieve, from a database, information of a location of the work task;
program instructions to retrieve, from the database, information of agent locations determined by a satellite navigation system;
program instructions to select one or more candidate agents who are within a predetermined range of the location of the work task, based on the agent locations determined by the satellite navigation system;
program instructions to retrieve, from agent devices of the one or more candidate agents, network node data of routers or repeaters in a network;
program instructions to retrieve, from the database, location information of the routers or the repeaters;
program instructions to determine locations of the one or more candidate agents, based on the location information of the routers or the repeaters; and
program instructions to choose a best available agent for the work task from the one or more candidate agents, based on the location of the work task and the locations of the one or more candidate agents.

9. The computer program product of claim 8, further comprising:
program instructions to update, on the database, the information of the agent locations determined by the satellite navigation system, at a predetermined time interval.

10. The computer program product of claim 8, wherein the network node data of the routers or the repeaters include IP addresses of the routers or MAC addresses of the repeaters.

11. The computer program product of claim 9, wherein the best available agent is so chosen from the one or more candidate agents that the best available agent is closest to the location of the work task.

12. The computer program product of claim 9, wherein criteria of choosing the best available agent comprise locations, skills, and workloads of the one or more candidate agents.

13. The computer program product of claim 9, wherein the agent devices are mobile computing devices including smartphones, tablet computers, or laptop computers.

14. The computer program product of claim 9, wherein the routers or the repeaters provide the agent devices with wireless access to the network.

15. A computer system for intelligently assigning a work task to an agent, the computer system comprising:
one or more processors, one or more computer-readable tangible storage devices, and program instructions stored on at least one of the one or more storage devices for execution by at least one of the one or more processors, the program instructions comprising:
program instructions to receive a request for assigning the work task to the agent;
program instructions to retrieve, from a database, information of a location of the work task;
program instructions to retrieve, from the database, information of agent locations determined by a satellite navigation system;
program instructions to select one or more candidate agents who are within a predetermined range of the location of the work task, based on the agent locations determined by the satellite navigation system;
program instructions to retrieve, from agent devices of the one or more candidate agents, network node data of routers or repeaters in a network;
program instructions to retrieve, from the database, location information of the routers or the repeaters;
program instructions to determine locations of the one or more candidate agents, based on the location information of the routers or the repeaters; and
program instructions to choose a best available agent for the work task from the one or more candidate agents, based on the location of the work task and the locations of the one or more candidate agents.

16. The computer system of claim 15, further comprising:
program instructions to update, on the database, the information of the agent locations determined by the satellite navigation system, at a predetermined time interval.

17. The computer system of claim 15, wherein the network node data of the routers or the repeaters include IP addresses of the routers or MAC addresses of the repeaters.

18. The computer system of claim 15, wherein the best available agent is so chosen from the one or more candidate agents that the best available agent is closest to the location of the work task.

19. The computer system of claim 15, wherein criteria of choosing the best available agent comprise locations, skills, and workloads of the one or more candidate agents.

20. The computer system of claim 15, wherein the agent devices are mobile computing devices including smartphones, tablet computers, or laptop computers, and wherein the routers or the repeaters provide the agent devices with wireless access to the network.
